(19) United States
(12) Patent Application Publication
(10) Pub. No.: US 2016/0151940 A1
(43) Pub. Date: Jun. 2, 2016

(54) DOUBLE BELT PRESS APPARATUS

(71) Applicants: Hyundai Motor Company, Seoul (KR); Kia Motors Corporation, Seoul (KR)

(72) Inventors: Hyun Min Kang, Seongnam (KR); Deok Woo Yun, Hwaseong (KR)

(21) Appl. No.: 14/696,915

(22) Filed: Apr. 27, 2015

(30) Foreign Application Priority Data
Nov. 28, 2014 (KR) 10-2014-0168285

(51) Int. Cl. B29C 35/02; B29C 70/04; B29C 70/42

(52) U.S. Cl. CPC B29C 35/0288; B29C 70/42; B29C 70/04; B29K 2101/12

(57) ABSTRACT

Disclosed is a double belt press apparatus including one pair of front double belts arranged on an upper side and a lower side of a fiber material, respectively, being continuously supplied thereto to rotate in opposite directions and pressing the fiber material from the upper side and the lower side while conveying the fiber material, at least three front conveying rollers moving the front double belts, one pair of rear double belts arranged on a downstream side of the front double belts on an upper side and a lower side of the fiber material, respectively, being continuously supplied thereto to rotate in opposite directions and pressing the fiber material from the upper side and the lower side while conveying the fiber material, at least three rear conveying rollers moving the rear double belts, and a pressure maintaining jig provided between the front double belts and the double belts applying a predetermined pressure to the fiber material being conveyed from the front double belts to the rear double belts.

### CROSS-REFERENCE TO RELATED APPLICATION

This application claims priority to and the benefit of Korean Patent Application No. 1 0-201 4-01 68285 filed in the Korean Intellectual Property Office on Nov. 28, 2014, the entire contents of which are incorporated herein by reference.

### BACKGROUND

(a) Technical Field

The present disclosure relates generally to a double belt press apparatus. More particularly, the present disclosure relates to a double belt press apparatus which enables precise and uniform temperature control at the time of fabrication of a self-reinforcing composite material.

(b) Description of the Related Art

Composite materials have been recently developed which have the strength of a metal with the lightness and formability of a plastic. Notable composite materials with high strength and high elasticity include high-tech, reinforcing composite materials for lightweight structure, often composed of a fiber (e.g., carbon fiber). As an example, fiber reinforced plastic (RFP), and particularly carbon fiber reinforced plastic (CFRP), have been employed.

However, while it is possible to use a continuous fiber-reinforced composite material as a structural element which may replace existing metals owing to a physical property reinforcing effect thereof, conventional use of continuous fiber-reinforced composite materials is limited to space aviation and expensive vehicles due to its high cost resulting from low productivity and low recyclability. Further, there a problem can arise when applying the continuous fiber-reinforced composite material to an exterior panel of a vehicle, since achieving an excellent surface characteristic is difficult due to a difference of shrinkages between the fiber and a base material, creating an obstacle for expanding use of the continuous fiber-reinforced composite material.

In order to solve this problem, a self-reinforced composite material has been developed. The self-reinforced composite material is a new concept material in which a polymer matrix of a thermoplastic resin is reinforced with a thermoplastic polymer, resulting in a lower density than an existing continuous fiber-reinforced composite material, and allowing a modulus of elasticity of a level of a discontinuous fiber-reinforced composite material, such as a sheet molding compound (SMC) and long-fiber reinforced thermoplastics (LFT). Since the self-reinforced composite material may be fabricated by a low-pressure, heated shaping of a low-price material (e.g., polypropylene or another thermoplastic resin), processing costs related to component shaping may be reduced. Moreover, since wear of a mold is low compared to glass/carbon fiber, a process maintenance cost may also be reduced.

Since the self-reinforced composite material uses a thermoplastic polymer material as the matrix and the reinforcing material, recyclability is higher than an existing general fiber-reinforced composite material. Moreover, since the reinforcing material and the matrix are identical materials, thus having the same shrinkages, the surface characteristic of the self-reinforced composite material is excellent.

In order to fabricate the self-reinforced composite material, selective melting of a material surface with fine temperature control is required. Consequently, a press apparatus is required for making fine control of a temperature being applied to the material and maintaining a pressure applied to the material uniform at the time of a press process of the material.

The above information disclosed in this Background section is only for enhancement of understanding of the background of the disclosure, and therefore, it may contain information that does not form the related art that is already known in this country to a person of ordinary skill in the art.

### SUMMARY

The present disclosure has been made in an effort to provide a double belt press apparatus having advantages of enabling precise and uniform temperature control when shaping a self-reinforcing composite material. Thus, an object of the present disclosure for solving the foregoing problem is to provide a double belt press apparatus which enables fine control of a temperature being applied to the material and to maintain a pressure applied to the material uniform during a press process of the material.

To achieve the objects of the present disclosure, a double belt press apparatus may include: one pair of front double belts arranged on an upper side and a lower side of a fiber material, respectively, being continuously supplied thereto to rotate in opposite directions and pressing the fiber material from the upper side and the lower side while conveying the fiber material; at least three front conveying rollers moving the front double belts; one pair of rear double belts arranged on a downstream side of the front double belts on an upper side and a lower side of the fiber material, respectively, being continuously supplied thereto to rotate in opposite directions and pressing the fiber material from the upper side and the lower side while conveying the fiber material; at least three rear conveying rollers moving the rear double belts; and a pressure maintaining jig provided between the front double belts and the rear double belts applying a predetermined pressure to the fiber material being conveyed from the front double belts to the rear double belts.

The pressure maintaining jig may be provided as one pair of pressure maintaining jigs applying the predetermined pressure to the upper side and the lower side of the fiber material.

The pressure maintaining jig may include a supporting portion supporting the fiber material being conveyed from the front double belts to the rear double belts, and a connecting portion connected to the supporting portion transmitting heat from a heat source to the supporting portion.

The supporting portion may have a bottom surface to be brought into contact with the fiber material, the bottom surface having a coated portion with a coat of a low friction material applied thereto.

The coated portion may have a Teflon coating or a diamond-like carbon (DLC) coating.

The supporting portion may have a taper portion matched to a radius of curvature of the conveying rollers formed on both sides of the supporting portion.

The supporting portion and the connecting portion may be formed of a metal.

The at least three front conveying rollers are provided as four conveying rollers provided in each of the front double belts and the rear double belts to form a rectangular shape.

The apparatus may further include a first heating unit provided in the front double belts heating the fiber material.

The apparatus may further include a second heating unit provided in the rear double belts heating the fiber material.

The double belt press apparatus of the present disclosure permits precise temperature control by having the double belt press apparatus provided with press apparatuses separated in view of temperature control sections. Further, the pressure maintaining jig provided between respective press apparatuses permits a pressure to be applied to the fiber material uniform when the fiber material is being conveyed.

### BRIEF DESCRIPTION OF THE DRAWINGS

Since the drawings are provided as a reference for describing illustrative embodiments of the present disclosure, it is required that technical aspects of the present disclosure should not be interpreted as being limited by the accompanying drawings.

FIG. 1 illustrates a block diagram of a self-reinforced composite material fabrication process in accordance with embodiments of the present disclosure.

FIG. 2 illustrates a schematic view of a double belt press apparatus in accordance with embodiments of the present disclosure.

FIG. 3 illustrates a schematic view of a pressure maintenance jig in accordance with embodiments of the present disclosure.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

Parts not relevant to the present disclosure will be omitted for describing the present disclosure clearly, and throughout the specification, identical or similar parts will be given the same reference numbers. Further, since sizes and thicknesses of elements are shown at will for convenience of description, the present disclosure is not limited to the drawings without fail, but the thicknesses are enlarged for clearly expressing different parts and regions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, lo a hybrid vehicle is a vehicle that has two or more sources of power, for example both gasoline-powered and electric-powered vehicles.

Hereafter, a double belt press apparatus in accordance with embodiments of the present disclosure will be described in detail with reference to the attached drawings.

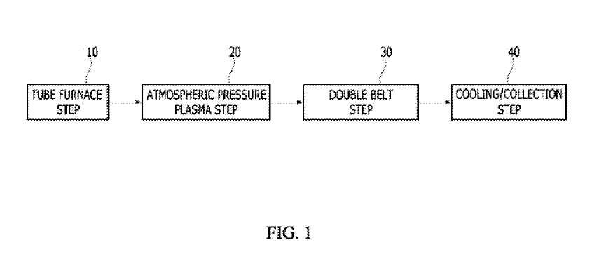

FIG. 1 illustrates a block diagram of a self-reinforced composite material fabrication process in accordance with embodiments of the present disclosure.

As shown in FIG. 1, a plurality of fabricating steps are required for fabricating a self-reinforced composite material in accordance with embodiments of the present disclosure. For example, a process for fabricating the self-reinforced composite material may include a tube furnace step 10, an atmospheric pressure plasma step 20, a double belt lamination step 30, and a cooling/collection step 40.

First, in the tube furnace step 10, sizing and impurity removal of a fiber material is carried out. In the atmospheric pressure plasma step 20, an interface characteristic of the fiber material is controlled. In the double belt lamination step 30, a surface of the fiber material is heated for changing properties of the fiber material, or a film is coated on the fiber material. Finally, in the cooling/collection step 40, the fiber material heated thus is cooled and collected. Thus, the double belt press apparatus presses and heats the fiber material in the double belt lamination step 30.

The double belt press apparatus 300 in accordance with embodiments of the present disclosure will be described in detail with reference to the attached drawings.

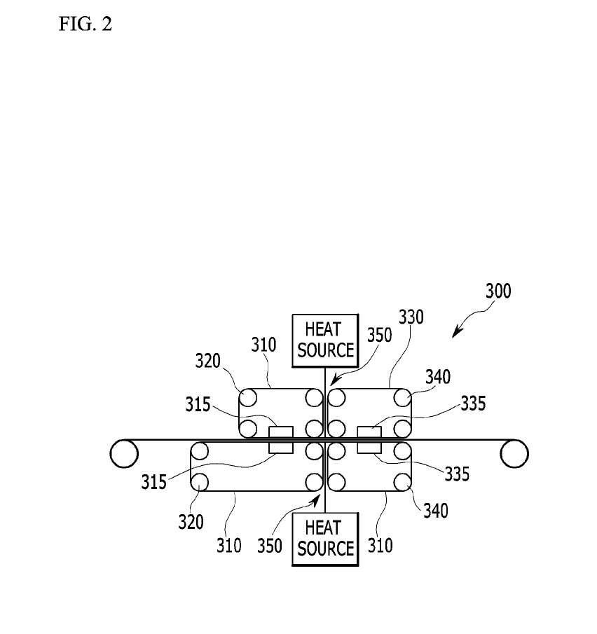

FIG. 2 illustrates a schematic view of a double belt press apparatus in accordance with embodiments of the present disclosure.

As shown in FIG. 2, the double belt press apparatus in accordance with a preferred embodiment of the present disclosure includes one pair of front double belts 310, one pair of rear double belts 330 provided downstream of the one pair of front double belts 310, and a pressure maintaining jig 350 provided between the one pair of front double belts 310 and the one pair of rear double belts 330.

The one pair of front double belts 310 are arranged on an upper side and a lower side of the fiber material being continuously supplied thereto to rotate in opposite directions for pressing the fiber material from the upper side and the lower side thereof while conveying the fiber material.

There are at least three front conveying rollers 320 provided to the one pair of front double belts 310 for moving the front double belts 310. In this case, it is preferable that there are four front conveying rollers 320 to form the one pair of front double belts 310 to be rectangular on the whole.

The one pair of rear double belts 330 are arranged on an upper side and a lower side of the fiber material being continuously supplied thereto to rotate in opposite directions for pressing the fiber material from the upper and lower sides while conveying the fiber material.

There are at least three rear conveying rollers 340 provided to the one pair of rear double belts 330 for moving the rear double belts 330. In this case, it is preferable that there are four rear conveying rollers 340 to form the one pair of rear double belts 330 to be rectangular.

Thus, by providing four front conveying rollers 320 and four rear conveying rollers 340, a space that the one pair of front double belts 310 and the one pair of rear double belts 330 occupy may be optimized. The smaller the diameters of the front conveying rollers 320 and the rear conveying rollers 340 are, the more the space occupied by the front conveying rollers 320 and the rear conveying rollers 340 may be minimized. However, if the diameters of the front conveying rollers 320 and the rear conveying rollers 340 are too small, an adequate torque may not be provided. Therefore, it is preferable that the diameters of the front conveying rollers 320 and the rear conveying rollers 340 are set by taking a driving torque which may convey the fiber material and a possible space in view of design into account.

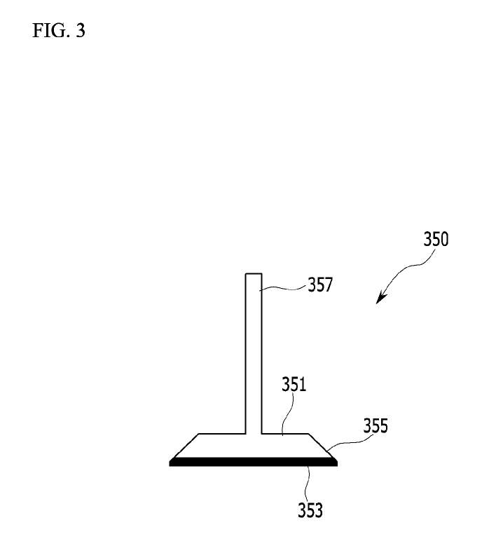

FIG. 3 illustrates a schematic view of a pressure maintenance jig in accordance with embodiments of the present disclosure.

As shown in FIG. 3, the pressure maintaining jig 350 may be provided as one pair between the one pair of front double belts 310 and the one pair of rear double belts 330 for applying a predetermined pressure to the upper side and the lower side of the fiber material being conveyed from the front double belts 310 to the rear double belts 330.

The pressure maintaining jig 350 may include a supporting portion 351 for supporting the fiber material being conveyed from the front double belts 310 to the rear double belts 330 and a connecting portion 357 connected to the supporting portion 351 for transmitting heat from a heat source to the supporting portion 351.

The supporting portion 351 and the connecting portion 357 are formed of a metal for transferring the heat from the heat source to the fiber material to heat the fiber material. It is preferable that a bottom surface of the supporting portion 351 to be brought into contact with the fiber material has a coated portion 353 having a coat of a low friction material applied thereto. The coated portion 353 may have a Teflon coating or a diamond-like carbon (DLC) coating. Since the pressure maintaining jig 350 is provided for applying a predetermined pressure to the fiber material being conveyed between the one pair of front double belts 310 and the one pair of rear double belts 330, it is preferable that the bottom surface of the supporting portion 351 to be brought into contact with the fiber material is coated with a low friction material described above for the fiber material to smoothly move.

Further, the connecting portion 357 may receive the heat from the heat source and transmit the heat at a predetermined rate to the fiber material through the supporting portion 351, as required. That is, even if a fabrication process of the fiber material is changed, it is possible to add a required heating step by using the pressure maintaining jig 350. The supporting portion 351 has a taper portion 355 matched to a radius of curvature of the conveying roller formed on both sides of the supporting portion. By forming the taper portion 355, interference between the supporting portion 351 and the one pair of front double belts 310 and the one pair of rear double belts 330 is prevented when the one pair of front double belts 310 and the one pair of rear double belts 330 are operated.

Referring to FIG. 2 again, a first heating unit 315 for heating the fiber material is provided in the one pair of front double belts 310, and a second lo heating unit 335 for heating the fiber material is provided in the one pair of rear double belts 330. In order to change physical properties of the fiber material, it is required to heat the fiber material to a temperature higher than 100° C. Further, in order to improve the physical properties of the fiber material and partially melt a surface of the fiber material as required, the heat generated by the first heating unit 315 or the second heating unit 335 must be controlled.

In this case, a section where the fiber material passes the first heating unit 315 of the one pair of front double belts 310 may be defined as a first temperature control section. Further, a section where the fiber material passes the temperature maintaining jig 350 may be defined as a second temperature control section. In addition, a section where the fiber material passes the second heating unit 335 of the one pair of rear double belts 330 may be defined as a third temperature control section.

The first temperature control section and the second temperature control section are separated by the one pair of front double belts 310 and the one pair of rear double belts 330. Therefore, transmission of the heat from the first temperature control section to the second temperature control section through the belt may be blocked. Therefore, precise temperature control is possible when the fiber material is melted or locally cooled with the first heating unit 315 and the second heating unit 335.

Further, the pressure maintaining jig 350 is provided between the one pair of front double belts 310 and the one pair of rear double belts 330, and the pressure maintaining jig 350 may receive the heat from the heat source and apply the heat at a predetermined rate to the fiber material. Therefore, the fiber material may be selectively heated according to a fabrication process of the fiber material.

The operation of the double belt press apparatus 300 in accordance with embodiments of the present disclosure will now be described.

The fiber material having passed through the tube furnace step 10 and the atmospheric pressure plasma step 20 is supplied to the double belt press apparatus 300. The fiber material introduced to the one pair of front double belts 310 is pressed by the one pair of front double belts 310 and heated by the first heating unit 315.

The fiber material passed through the one pair of front double belts 310 is introduced to the one pair of rear double belts 330 after passing through the pressure maintaining jig 350. The fiber material may be heated by the pressure maintaining jig 350, as required.

The fiber material introduced to the one pair of rear double belts 330 is pressed by the one pair of rear double belts 330 and heated by the second heating unit 335. Finally, the fiber material pressed and heated by the one pair of rear double belts 330 is cooled to room temperature and collected in the cooling/collection step 40.

As described above, the double belt press apparatus 300 in accordance with embodiments of the present disclosure blocks transmission of the heat from one temperature control section to the other temperature control section through the belt because the temperature control section is separated physically by the front double belts 310 and the rear double belts 330. Therefore, individual heating temperatures at respective temperature control sections may be precisely controlled. Moreover, the pressure maintaining jig 350 provided between the front double belts 310 and the rear double belts 330 for supplying the heat permits positively dealing with a change of the fabrication process of the fiber material, and maintaining a uniform pressure on the fiber material when the fiber material is conveyed from the front double belts 310 to the rear double belts 330.

While this disclosure has been described in connection with what is presently considered to be embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: tube furnace step
20: atmospheric pressure plasma step
30: double belts lamination step
40: cooling/collection step
300: double belt press apparatus
310: front double belts
315: first heating unit
320: front conveying roller
330: rear double belts
335: second heating unit
340: rear conveying roller
350: pressure maintaining jig
351: supporting portion
353: coated portion
355: taper portion
357: connecting portion

What is claimed is:

1. A double belt press apparatus comprising:
one pair of front double belts arranged on an upper side and a lower side of a fiber material, respectively, being continuously supplied thereto to rotate in opposite directions and pressing the fiber material from the upper side and the lower side while conveying the fiber material;
at least three front conveying rollers moving the front double belts;
one pair of rear double belts arranged on a downstream side of the front lo double belts on an upper side and a lower side of the fiber material, respectively, being continuously supplied thereto to rotate in opposite directions and pressing the fiber material from the upper side and the lower side while conveying the fiber material;
at least three rear conveying rollers moving the rear double belts; and
a pressure maintaining jig provided between the front double belts and the rear double belts applying a predetermined pressure to the fiber material being conveyed from the front double belts to the rear double belts.

2. The apparatus of claim 1, wherein the pressure maintaining jig is provided as one pair of pressure maintaining jigs applying the predetermined pressure to the upper side and the lower side of the fiber material.

3. The apparatus of claim 1, wherein the pressure maintaining jig includes:
a supporting portion supporting the fiber material being conveyed from the front double belts to the rear double belts, and
a connecting portion connected to the supporting portion transmitting heat from a heat source to the supporting portion.

4. The apparatus of claim 3, wherein the supporting portion has a bottom surface to be brought into contact with the fiber material, the bottom surface having a coated portion with a coat of a low friction material applied thereto.

5. The apparatus of claim 4, wherein the coated portion has a Teflon coating or a diamond-like carbon (DLC) coating.

6. The apparatus of claim 3, wherein the supporting portion has a taper portion matched to a radius of curvature of the conveying rollers formed on both sides of the supporting portion.

7. The apparatus of claim 3, wherein the supporting portion and the connecting portion are formed of a metal.

8. The apparatus of claim 1, wherein the at least three front conveying rollers are provided as four conveying rollers provided in each of the front double belts and the rear double belts to form a rectangular shape.

9. The apparatus of claim 1, further comprising a first heating unit provided in the front double belts heating the fiber material.

10. The apparatus of claim 1, further comprising a second heating unit provided in the rear double belts heating the fiber material.
